(19) United States
(12) Patent Application Publication
(10) Pub. No.: US 2008/0058088 A1
(43) Pub. Date: Mar. 6, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/790,193

(22) Filed: Apr. 24, 2007

Related U.S. Application Data
(60) Provisional application No. 60/842,019, filed on Sep. 5, 2006.

(51) Int. Cl. A63F 13/00

(52) U.S. Cl. 463/21

(57) ABSTRACT

A slot machine according to the present invention comprises: a display to which a plurality of symbols are arranged; a selection switch for selecting a symbol that is to be a particular symbol, out of the plurality of symbols; and a controller, and the controller determines the symbol corresponding to an input from the selection switch as the particular symbol, changes a display mode of the determined particular symbol, and allots a prize in an event that a predetermined number or more of at least one particular symbol is arranged to the display as a result of rearrangement of the plurality of symbols arranged to the display.

### CROSS-REFERENCE TO RELATED APPLICATIONS

This application claims priority of U.S. Provisional Application No. 60/842,019 filed on Sep. 5, 2006. The contents of this application are incorporated herein by reference in their entirety.

### BACKGROUND OF THE INVENTION

1. Field of the Invention

The present invention relates to a slot machine and a playing method thereof.

2. Discussion of the Background

In a conventional slot machine, if a player inserts gaming media such as coins or bills into an insertion slot and pushes a spin button, then a plurality of symbols are displayed in a scrolling manner on a display provided on the front surface of a casing and, thereafter, the respective symbols are automatically stopped.

Among slot machines of this kind, there are slot machines which pay out a predetermined number of game media, in an event that the combination of symbols rearranged along a winning line is a predetermined winning combination, and also pay out a predetermined number of game media according to the number of symbols called scatter symbols arranged on a display, regardless of the winning line, as disclosed in, for example, U.S. Pat. No. 6,604,999 and US 2002-0065124-A1.

The present invention provides a slot machine and a playing method thereof which have entertainment characteristics which have not been offered by the aforementioned conventional art.

The contents of U.S. Pat. No. 6,604,999 and US 2002-0065124-A1 are incorporated herein by reference in their entirety.

### SUMMARY OF THE INVENTION

A slot machine according to the first aspect of the present invention provides a slot machine having the following configuration.

That is, a slot machine according to the first aspect of the present invention comprises: a display to which a plurality of symbols are arranged; a selection switch for selecting a symbol that is to be a particular symbol, out of the plurality of symbols; and a controller. In the above-mentioned slot machine, the controller determines the symbol corresponding to an input from the selection switch as the particular symbol, changes a display mode of the determined particular symbol, and allots a prize in an event that a predetermined number or more of at least one particular symbol is arranged to the display as a result of rearrangement of the plurality of symbols arranged to the display.

A slot machine according to the second aspect of the present invention provides a slot machine having the following configuration.

That is, a slot machine according to the second aspect of the present invention comprises: a display to which a plurality of symbols are arranged; a selection switch for selecting a symbol that is to be a particular symbol, out of the plurality of symbols; and a controller. In the above-mentioned slot machine, the controller determines the symbol corresponding to an input from the selection switch as the particular symbol, displays displaying an overlay image for indicating the particular symbol on the determined particular symbol, and allots a prize, in an event that a predetermined number or more of at least one particular symbol is arranged to the display as a result of rearrangement of the plurality of symbols arranged to the display.

A slot machine according to the third aspect of the present invention provides a slot machine having the following configuration.

That is, a slot machine according to the third aspect of the present invention comprises: a display to which a plurality of symbols are arranged; a selection switch for selecting a symbol that is to be a particular symbol, out of the plurality of symbols; and a controller. In the above-mentioned slot machine, the controller determines the symbol corresponding to an input from the selection switch as the particular symbol, displays an overlay image for indicating the particular symbol on the determined particular symbol, after rearrangement of the plurality of symbols arranged to the display, and allots a prize, in an event that a predetermined number or more of at least one particular symbol is arranged to the display as a result of rearrangement of the plurality of symbols arranged to the display.

A playing method of a slot machine according to the fourth aspect of the present invention provides a playing method of a slot machine having the following configuration.

That is, a playing method of a slot machine according to the fourth aspect of the present invention comprises the steps of: receiving an input from a selection switch for selecting a symbol that is to be a particular symbol, out of a plurality of symbols arranged to a display, determining the symbol corresponding to the input from the selection switch as the particular symbol, changing a display mode of the determined particular symbol, and allotting a prize, in an event that a predetermined number or more of at least one particular symbol is arranged to the display as a result of rearrangement of the plurality of symbols arranged to the display.

A playing method of a slot machine according to the fifth aspect of the present invention provides a playing method of a slot machine having the following configuration.

That is, a playing method of a slot machine according to the fifth aspect of the present invention comprises the steps of: receiving an input from a selection switch for selecting a symbol that is to be a particular symbol, out of a plurality of symbols arranged to a display, determining the symbol corresponding to an input from the selection switch as the particular symbol, displaying an overlay image for indicating the particular symbol on the determined particular symbol, and allotting a prize, in an event that a predetermined number or more of at least one particular symbol is arranged to the display as a result of rearrangement of the plurality of symbols arranged to the display.

A playing method of a slot machine according to the sixth aspect of the present invention provides a playing method of a slot machine having the following configuration.

That is, a playing method of a slot machine according to the sixth aspect of the present invention comprises the steps of: receiving an input from a selection switch for selecting a symbol that is to be a particular symbol, out of a plurality of symbols arranged to a display, determining the symbol corresponding to an input from the selection switch as the particular symbol, displaying an overlay image for indicating the particular symbol on the determined particular symbol, after rearrangement of the plurality of symbols arranged to the display, and allotting a prize, in an event that a predetermined number or more of at least one particular symbol is arranged to the display as a result of rearrangement of the plurality of symbols arranged to the display.

### BRIEF DESCRIPTION OF THE DRAWINGS

FIG. 1 is a view illustrating an exemplary image displayed when scatter symbols are determined.

FIG. 2A is a view illustrating exemplary symbols arranged on a lower image display panel.

FIG. 2B is another view illustrating exemplary symbols arranged on the lower image display panel.

FIG. 2C is still another view illustrating exemplary symbols arranged on the lower image display panel.

FIG. 2D is still further another view illustrating exemplary symbols arranged on the lower image display panel.

FIG. 3 is a perspective view illustrating an external appearance of a slot machine according to one embodiment of the present invention.

FIG. 4 is a view illustrating symbols and code numbers of the respective symbols.

FIG. 5 is a block diagram illustrating an internal structure of the slot machine illustrated in FIG. 3.

FIG. 6 is a view illustrating a relationship between combination prizes and numbers of coins to be paid out.

FIG. 7 is a view illustrating a relationship between scatter prizes and numbers of coins to be paid out.

FIG. 8 is a flow chart illustrating a subroutine of game executing processing.

FIG. 9 is a flow chart illustrating a subroutine of scatter symbol selection processing.

FIG. 10 is a flowchart illustrating a subroutine of symbol determination processing.

FIG. 11 is a flow chart illustrating a subroutine of bonus game processing.

FIG. 12A is a view illustrating another example of symbols arranged on the lower image display panel.

FIG. 12B is a view illustrating still another example of symbols arranged on the lower image display panel.

FIG. 12C is a view illustrating still further another example of symbols arranged on the lower image display panel.

FIG. 12D is a view illustrating still further another example of symbols arranged on the lower image display panel.

FIG. 12E is a view illustrating still further another example of symbols arranged on the lower image display panel.

### DESCRIPTION OF THE EMBODIMENTS

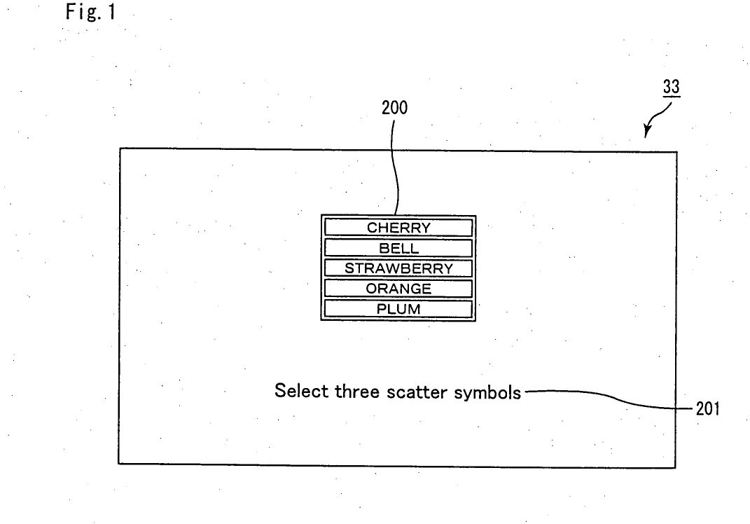

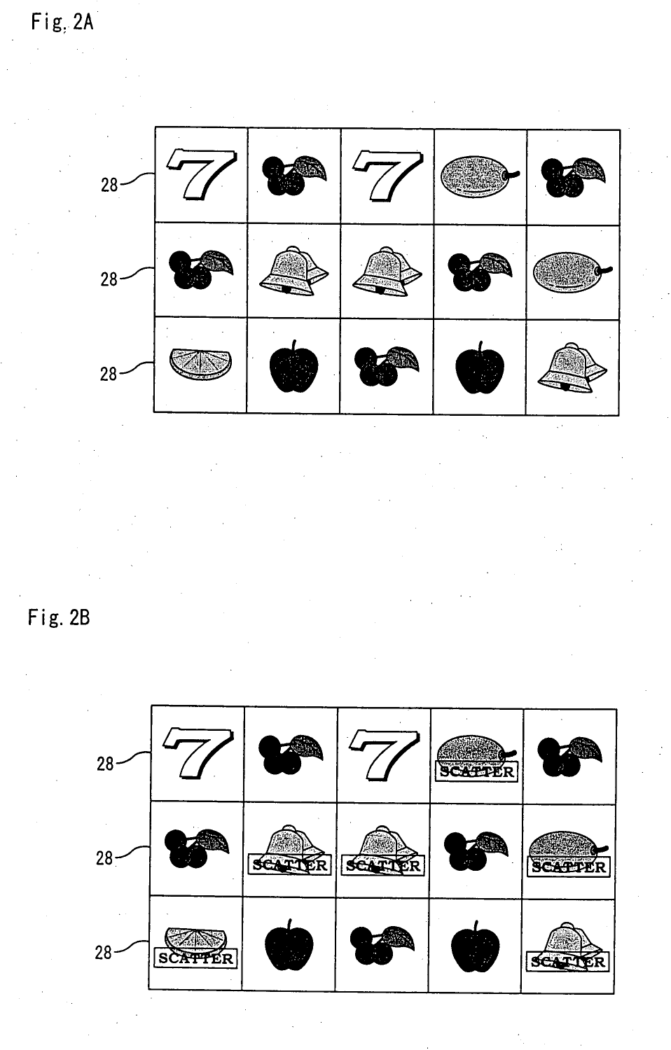

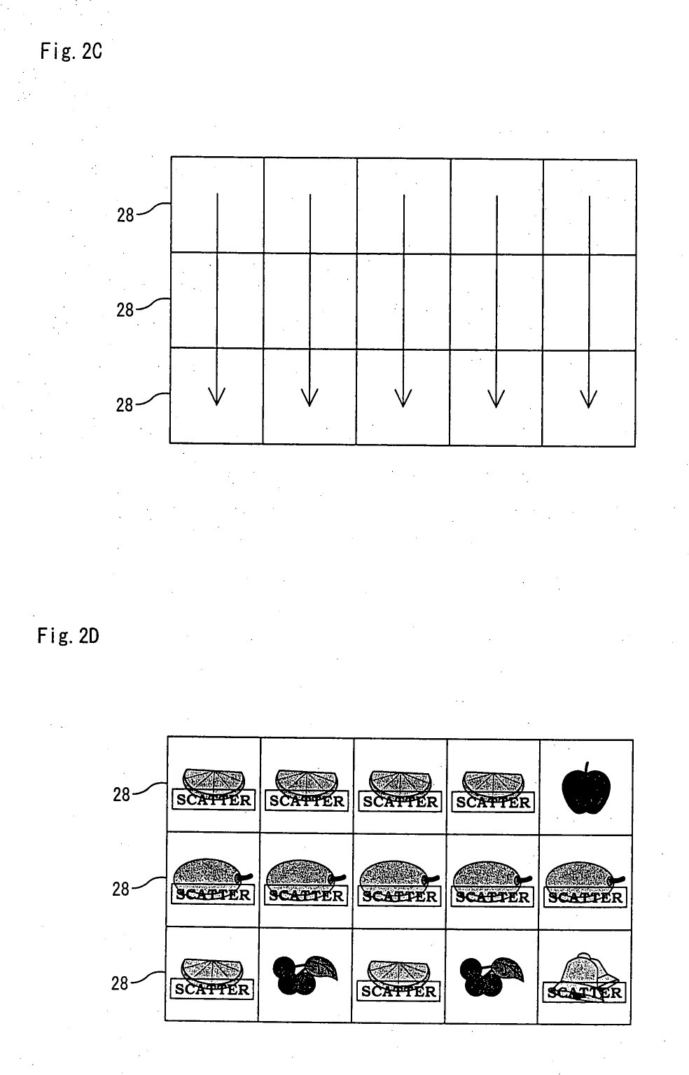

FIG. 1 is a view illustrating an exemplary image which is displayed when scatter symbols are determined. FIGS. 2A to 2D are views illustrating one example of symbols which are arranged on a lower image display panel. Although, the slot machine 10 is a standalone type slot machine which is not connected to a network, the present invention may be applied to a slot machine connected to a network.

The lower image display panel 16 included in the slot machine 10 according to the present invention is comprised of a liquid crystal display panel, and displays fifteen display blocks 28 in five columns and three rows as shown in FIGS. 2A to 2D. One symbol is arranged in each display block 28. In the present embodiment, any one of “CHERRY”, “BELL”, “STRAWBERRY”, “ORANGE”, “PLUM”, “BLUE7”, “JACKPOT7” and “APPLE” symbols is arranged in each display blocks 28.

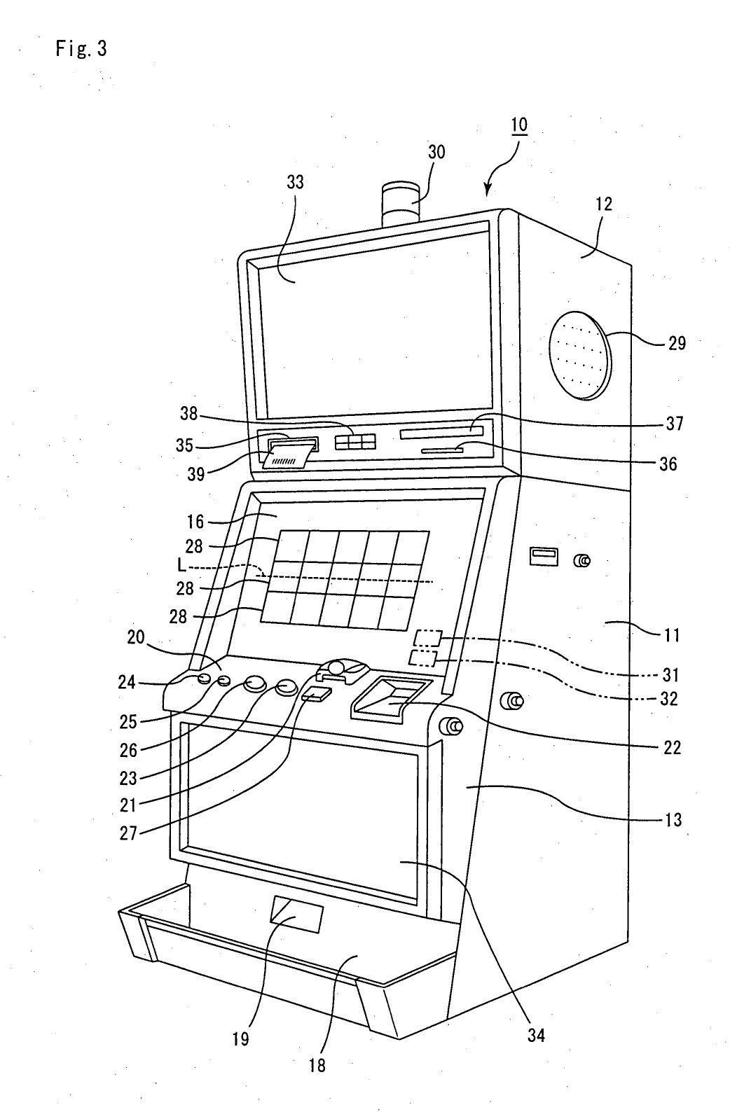

Further, on the lower image display panel 16, there is formed one winning line L that horizontally crosses the five display blocks 28 displayed at the middle of the respective column (see FIG. 3). The winning line L defines a combination of symbols.

At the start of a game, namely when a spin button 23 is turned on, or when the number of games reaches a predetermined number, an image illustrated in FIG. 1 is displayed on an upper image display panel 33. When this image is displayed, the player can select scatter symbols. The scatter symbols are symbols as follows. That is, when a predetermined number or more of scatter symbols of the same type are arranged as a result of rearrangement of symbols, this event causes a winning, and thereby the prize payout is conducted. In the present embodiment, there will be described a case where a scatter prize will be allotted when three or more scatter symbols are arranged. In the slot machine 10, one or more symbols out of “CHERRY”, “BELL”, “STRAWBERRY”, “ORANGE” and “PLUM” may become scatter symbols. The player can input symbols that the player chooses as scatter symbols. The scatter symbols correspond to particular symbols in the present invention.

At a lower portion of the upper image display panel 33, there is displayed a number-of-selection image 201 depicting “Please select three symbols”. Further, at a center portion thereof, there is displayed a selection image 200 for selecting symbols. The selection image 200 is comprised of images indicating “CHERRY”, “BELL”, “STRAWBERRY”, “ORANGE” and “PLUM” in the mentioned order from the top. These images are images indicating symbols which can be selected. In the front surface of the upper image display panel 33, a touch panel 69 is provided. The player can input symbols that the player chooses as scatter symbols, by touching the portions of the selection image 200 corresponding to these symbols. The touch panel 69 corresponds to a selection switch according to the present invention.

For example, when “BELL”, “ORANGE” and “PLUM” are input through the touch panel 69 while the symbols illustrated in FIG. 2A are arranged on the lower image display panel 16, overlay images indicating “SCATTER” are displayed in a superposed manner on the symbols “BELL”, “ORANGE” and “PLUM” (see FIG. 2B). Namely, this display indicates that “BELL”, “ORANGE” and “PLUM” are scatter symbols.

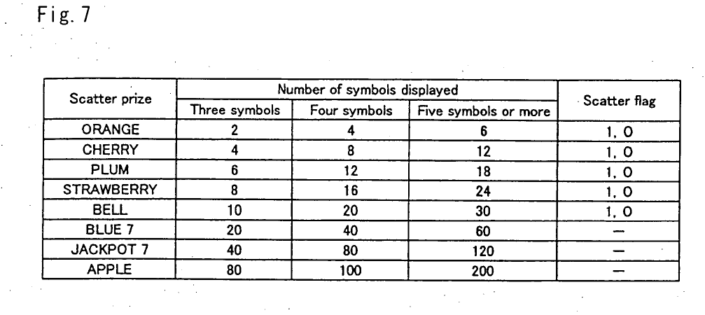

Thereafter, scrolling of symbols is started on the lower image display panel 16 (see FIG. 2C). Then, after elapse of a predetermined time period, symbols which have been scrolled are arranged as illustrated in FIG. 2D, for example. In FIG. 2D, overlay images are displayed in a superpose manner on the symbols “BELL”, “ORANGE” and “PLUM”. Further, in FIG. 2D, six “ORANGE” symbols, five “PLUM” symbols, two “CHERRY” symbols, one “BELL” symbol and one “APPLE” symbol are arranged. Accordingly, a scatter prize corresponding to the six “ORANGE” symbols and a scatter prize corresponding to the five “PLUM” symbols are to be allotted (see FIG. 7).

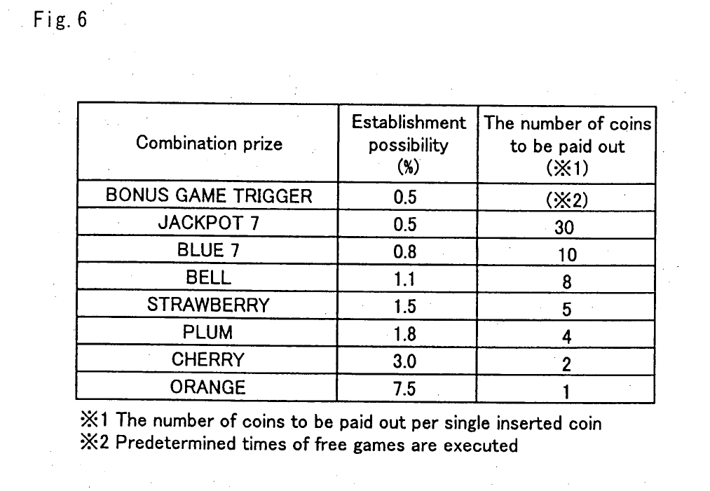

Also, when five “JACKPOT7” symbols, five “BLUE7” symbols, five “BELL” symbols, five “CHERRY” symbols, five “STRAWBERRY” symbols, five “PLUM” symbols, five “ORANGE” symbols or five “APPLE” symbols are arranged along the winning line L, then a predetermined number of coins are paid out. In the example illustrated in FIG. 2D, since the five “PLUM” symbols are arranged along the winning line L, a prize corresponding to this combination is allotted (see FIG. 6).

In the aforementioned example, there has been described a case where overlay images indicating “SCATTER” are displayed; however, such overlay images are not limited to “SCATTER” in the present invention.

Further, while there has been described a case where overlay images are displayed in a superposed manner on the scatter symbols, the present invention is not limited thereto and, for example, such overlay images can be displayed above or below the scatter symbols.

Moreover, in the aforementioned example, there has been described a case where, when scatter symbols are selected, overlay images are displayed in a superposed manner on these symbols; however, the present invention is not limited thereto, and symbols indicating scatter symbols can be displayed by replacing the selected symbols therewith. Examples of such symbols indicating scatter symbols include symbols having a size greater than the symbols to be replaced therewith, or symbols having an appearance that is to some degrees changed from that of the symbols to be replaced therewith.

In the aforementioned example, there has been described a case where overlay images are displayed prior to rearrangement of symbols; however, overlay images can be displayed after rearrangement of symbols in the present invention.

While, in the aforementioned example, there has been described a case where both a scatter prize and a combination prize are allotted, in the present invention, it is also possible to grant that there is no combination prize or it is possible to offer no combination prize in case of offering a scatter prize.

In the aforementioned example, there has been described a case where three symbols are selected as scatter symbols; however, in the present invention, one, two, four or more symbols can be selected or the number of symbols to be selected as scatter symbols (the number of selections) can be changed each time at random. While, in the aforementioned example, there has been described a case where scatter symbols are selected out of the five types of symbols “CHERRY”, “BELL”, “STRAWBERRY”, “ORANGE” and “PLUM”; however, in the present invention, the number of symbols from which the scatter symbols are selected may be four or less symbols or six or more symbols, or may be changed each time at random. Also, in the present invention, the symbols which can be selected are not limited to “CHERRY”, “BELL”, “STRAWBERRY”, “ORANGE” and “PLUM”, and may be any symbols or may be changed each time at random.

In the aforementioned example, there has been described a case where the input of selected symbols from the touch panel 69 is received when the number of games has reached a predetermined number; however, in the present invention, there is no particular limitation on the condition required to enable reception of input of selected scatter symbols and, for example, input of selections can be received each time a game is started or on condition that a predetermined prize has been allotted or no prize has been allotted.

While, in the aforementioned example, there has been described a case where a scatter prize is allotted if three or more scatter symbols are arranged, in the present invention a scatter prize may be allotted when one or more, two or more, or four or more scatter symbols are arranged.

While, in the aforementioned example, there has been described a case where symbols are selected as scatter symbols through the touch panel 69, in the present invention the selection switch is not limited thereto and may be separately provided.

While, in the aforementioned example, there has been described a case where a total of 15 symbols are arranged along 5 columns and 3 rows, the present invention is not limited to use of 5 columns and 3 rows. Further, while, in the aforementioned example, there has been described a case where symbols are displayed (arranged) on the lower image display panel 16 which is constituted by a liquid crystal display panel, the present invention is not limited thereto and, for example, mechanical reels can be placed at the back surface of a display (for example, a transparent liquid crystal display panel), and symbols can be arranged on the display using the mechanical reels. Further, while, in the aforementioned example, there has been described a case where symbols are scrolled in the vertical direction along the respective columns, in the present invention, respective symbols can be displayed individually. Further, in a case of employing the mechanical reels, it is possible to employ the same number of mechanical reels as the number of symbols to be arranged, thereby to enable scrolling respective symbols individually.

FIG. 3 is a perspective view illustrating an external appearance of a slot machine according to an embodiment of the present invention.

In the slot machine 10, a coin, a note or electronic valuable information corresponding thereto is used as a game media. In the present invention, however, the game media is not particularly limited, and for example, a medal, a token, an electronic money and a ticket can be used. The ticket is not particularly limited and may include, for example, a ticket with a bar code as described later, and of the like tickets.

The slot machine 10 includes: a cabinet 11; a top box 12 placed on the upper side of the cabinet 11; and a main door 13 provided at the front face of the cabinet 11.

The lower side image display panel 16 as a display is provided at the front of the main door 13. The lower image display panel 16 includes a liquid crystal panel which displays the 15 display blocks 28 along five columns and three rows. Each display block 28 arranges a single symbol.

Further, on the lower image display panel 16, there is formed one winning line L that horizontally crosses the five display blocks 28 displayed at the middle of the respective column. The winning line L defines a combination of symbols.

In the lower image display panel 16, there are provided a number-of-credits display section 31 and a number-of-payouts display section 32. The number-of-credits display section 31 displays an image indicating the number of credited coins. The number-of-payouts display section 32 displays an image indicating the number of coin-outs in an event that a predetermined combination of symbols is arranged along the winning line L (in an event of establishment of a combination prize) or in an event of establishment of a scatter prize.

Provided below the lower image display panel 16 are: a control panel 20 constituting of a plurality of buttons, buttons 23 to 27, with which commands associated with progress of the game are input by the player; a coin receiving slot 21 accepting coins into the cabinet 11; and a bill validator 22.

The control panel 20 is provided with: a spin button 23; a change button 24; a CASHOUT button 25; a 1-BET button 26; and a maximum BET button 27. The spin button 23 is used for inputting a command to start the scrolling of symbols. The change button 24 is used in a case where a player requests an attendant of a recreation facility to exchange money. The CASHOUT button 25 is used for inputting a command to pay out credited coins to a coin tray 18.

The 1-BET button 26 is used for inputting a command to bet one coin of the credited coins. The maximum BET button 27 is used for inputting a command to bet the maximum number of coins that can be bet on one game (50 coins in the present embodiment) of the credited coins.

The bill validator 22 is used not only for discriminating a false note from a true note but also for accepting the true note into the cabinet 11. The bill validator 22 may be configured such that a ticket 39 with a bar code which will be described later can be read. A belly glass 34 on which characters and the like of the slot machine 10 are depicted is provided on the front face of the lower portion of the main door 13, that is, below the control panel 20.

On a front surface of the top box 12, an upper image display panel 33 is provided. The upper image display panel 33 includes a liquid crystal display panel which displays, for example, images introducing the contents of games and explaining the rules of games. Further, selection images 200 for selecting symbols to be selected as scatter symbols are displayed on the upper image display panel 33.

Further, although not illustrated, the touch panel 69 is provided in the front surface of the upper image display panel 33, allowing the player to input various types of commands by operating the touch panel 69.

A speaker 29 is provided in the top box 12. A ticket printer 35, a card reader 36, a data display 37 and a key pad 38 are provided beneath the upper image display panel 33. The ticket printer 35 prints on a ticket a bar code in which data such as the number of credits, date, time, identification number of the slot machine 10 and of the like data are encoded, and outputs the ticket 39 with a bar code. A player can make the ticket 39 with a bar code to be read by a second slot machine and play a game in the second slot machine, or exchange in a predetermined place (for example, at a cashier in the casino) of a recreation facility the ticket 39 with a bar code to notes.

The card reader 36 is used for reading data from a smart card and writing data onto a smart card. The smart card is a card to be carried by a player, and for example, data to identify a player and data concerning a history of a game played by the player are stored thereon. Data corresponding to a coin, a note or a credit may also be stored on the smart card. As an alternative of a smart card, a magnetic stripe card may be adopted. The data display 37 is a fluorescent display and the like, and it is used, for example, to display data read by the card reader 36 and data input by a player from the key pad 38. The key pad 38 is used for inputting a command to issue a ticket and the like or data.

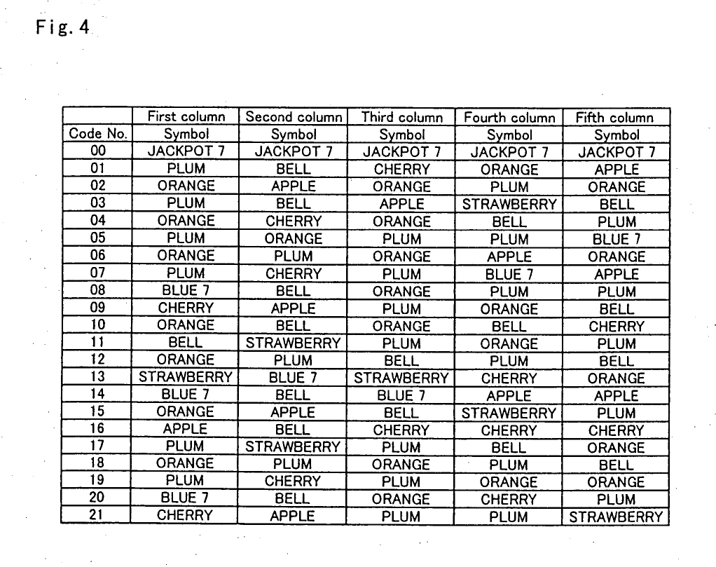

FIG. 4 is a view illustrating symbols and the code numbers of the respective symbols.

As illustrated in FIG. 4, a sequence of a total of 22 symbols having code numbers “00” to “21” are scrolled in each of the display blocks 28. Each symbol sequence is constituted by a combination of symbols of “JACKPOT7”, “BLUE7”, “BELL”, “CHERRY”, “STRAWBERRY”, “PLUM”, “ORANGE” and “APPLE”.

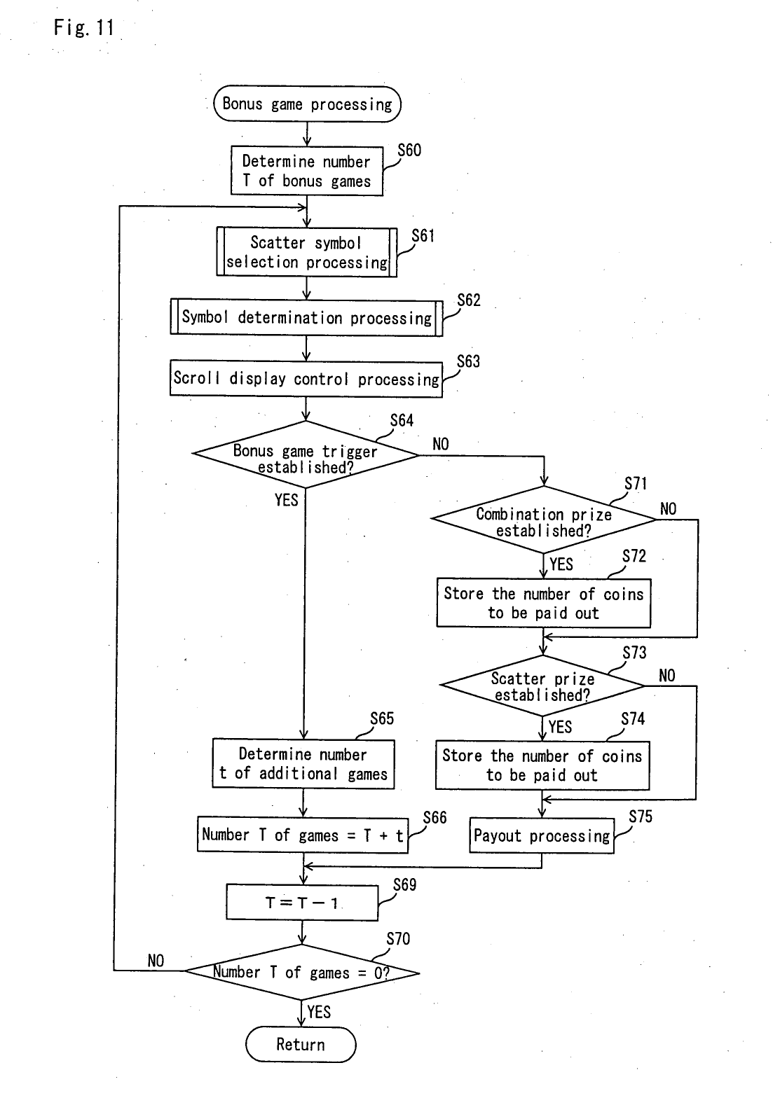

In an event that five “JACKPOT7” symbols, five “BLUE7” symbols, five “BELL” symbols, five “CHERRY” symbols, five “STRAWBERRY” symbols, five “PLUM” symbols, five “ORANGE” symbols or five “APPLE” symbols are rearranged along the winning line L (in an event of establishment of a combination prize), a predetermined number of coins are paid out (see FIG. 11). Further, in an event that a predetermined number or more of symbols of the same type are rearranged (in an event of establishment of a scatter prize), a predetermined number of coins are paid out (see FIG. 7).

When the spin button 23 is pushed to start games, after the 1-BET button 26 or the maximum-BET button 27 is pushed, symbols are displayed in such a manner that they are scrolled in the up-to-down direction. After the elapse of a predetermined time period, the scrolled symbols are rearranged. When a prize is established at this time, a predetermined number of coins are paid out (see FIG. 6 and FIG. 7).

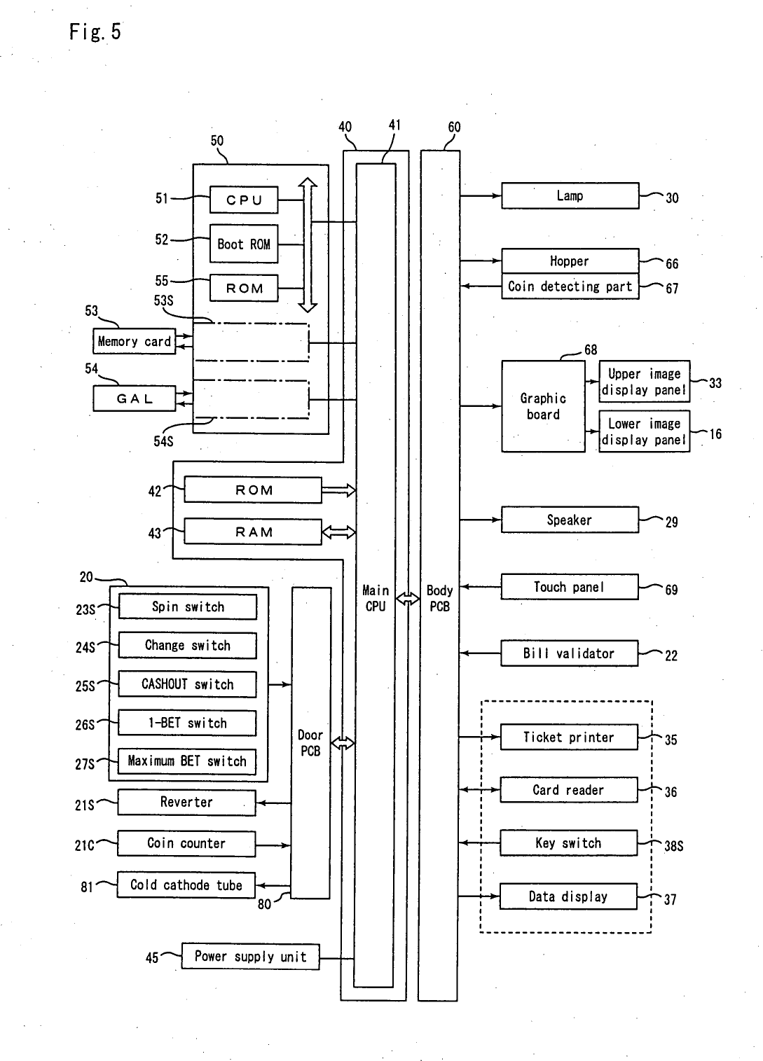

FIG. 5 is a block diagram showing the internal configuration of the slot machine shown in FIG. 3.

A gaming board 50 includes: CPU (Central Processing Unit) 51, ROM 55 and boot ROM 52 which are interconnected to one another by an internal bus; a card slot 53S which accepts a memory card 53; and an IC socket 54S which accepts GAL (Generic Array Logic) 54.

The memory card 53 is constituted of non-volatile memories such as CompactFlash (registered trademark) and stores a game program. The game program contains a symbol determination program. The symbol determination program is a program for determining symbols (code Nos. corresponding to the symbols) which are to be arranged along the winning line L.

The card slot 53S is configured so that the memory card 53 can be inserted therein or drawn out therefrom, and connected to a mother board 40 through IDE bus. Therefore, a kind or contents of a game played in the slot machine 10 can be changed by drawing out the memory card 53 from the card slot 53S, writing a different game program thereon, and inserting the memory card 53 into the card slot 53S thereafter. The game program includes a program related to progress in a game. The game program further includes: image data and sound data that are output while a game is played.

CPU 51, ROM 55 and boot ROM 52 interconnected to each other by the internal bus are connected to the mother board 40 by PCI bus. The PCI bus not only conducts signal transmission between the mother board 40 and the gaming board 50, but also supplies electric power to the gaming board 50 from the mother board 40.

The mother board 40 is constructed with a general-purpose mother board (a printed circuit board on which basic parts of a personal computer are mounted) which is commercially available, and includes: a main CPU 41; ROM (Read Only Memory) 42; RAM (Random Access Memory) 43 and a communication interface 44. The mother board 40 corresponds to the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is an initialization processing for predetermined peripheral devices conducted, but a capture processing for the game program stored on the memory card 53 is also started via the gaming board 50. In the present invention, contents of ROM 42 may be rewritable or not rewritable.

RAM 43 stores data and a program used at the time of operation of the main CPU 41. RAM 43 can store the game program.

RAM 43 further stores data on the number of credits, the number of coin-in or coin-out for one game, and the like.

Both a body PCB (Printed Circuit Board) 60 and a door PCB 80 which will be described later are connected to the mother board 40 by USB. A power supply unit 45 is also connected to the mother board 40.

Equipment and devices which generate input signals to be input to the main CPU 41, and equipment and devices of which operations are controlled by a control signal output from the main CPU 41 are connected to the body PCB 60 and the door PCB 80. The main CPU 41 executes a game program stored in RAM 43 based on the input signal input to the main CPU 41, and thereby performs a predetermined computational processing to store results thereof into RAM 43 and transmits a control signal to each equipment and device as a control processing for each of the equipment and devices.

A lamp 30, a hopper 66, a coin detecting section 67, a graphic board 68, a speaker 29, a touch panel 69, a bill validator 22, a ticket printer 35, a card reader 36, a key switch 38S and a data display 37 are connected to the body PCB 60. The lamp 30 is lit up in a predetermined pattern based on a control signal output from the main CPU 41.

The hopper 66 is installed in the cabinet 11 and pays out a predetermined number of coins from a coin payout exit 19 to a coin tray 18 based on a control signal output from the main CPU 41. A coin detecting section 67 is installed inside the coin payout exit 19 and, when detecting that a predetermined number of coins has been paid out from the coin payout exit 19, outputs an input signal to the main CPU 41.

The graphic board 68 controls, based on a control signal output from the main CPU 41, image displays on the upper image display panel 33 and the lower image display panel 16. In the respective display blocks 28 on the lower image display panel 16, symbols are displayed in a scrolling or rearranged manner. The number-of-credits display section 31 on the lower image display panel 16 displays the number of credits stored in the RAM 43. Further, the number-of-payouts display section 32 on the lower image display panel 16 displays the number of coin-outs.

The graphic board 68 is equipped with VDP (Video Display Processor) which generates image data based on a control signal output from the main CPU 41 and a video RAM which temporarily stores image data generated by VDP, and the like. Note that image data used in generating image data with VDP is read from the memory card 53 and contained in a game program stored in RAM 43.

The bill validator 22 not only discriminates a true note from a false note, but also accepts the true note into the cabinet 11. The bill validator 22, when accepting a true note, outputs an input signal to the main CPU 41 based on a face amount of the note. The main CPI 41 has the RAM 43 store the number of credits corresponding to the amount of the note transmitted with the input signal.

The ticket printer 35, based on a control signal output from the main CPU 41, prints on a ticket a bar code obtained by encoding data such as the number of credits, date and time, the identification number of the slot machine 10, and of the like data stored in RAM 43, and outputs the ticket 39 with a bar code.

The card reader 36 transmits to the main CPU 41 data read from the smart card and writes data onto the smart card based on a control signal from the main CPU 41. The key switch 38S is provided on the key pad 38, and when the key pad 38 is operated by a player, outputs a predetermined input signal to the main CPU 41. The data display 37 displays, based on a control signal output from the main CPU 41, data read by the card reader 36 and data input by a player through the key pad 38.

The control panel 20, a reverter 21S, a coin counter 21C and a cold cathode tube 81 are connected to the door PCB 80. The control panel 20 is provided with a spin switch 23s corresponding to the spin button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. When the buttons 23 to 27 are operated by a player, each of the corresponding switches 23S to 27S outputs input signals to the main CPU 41.

The coin counter 21C is installed inside the coin receiving slot 21, and discriminates whether a coin inserted by a player into the coin receiving slot 21 is true or false. Coins other than the true ones are discharged from the coin payout exit 19. The coin counter 21C also outputs an input signal to the main CPU 41 when a true coin is detected.

The reverter 21S operates based on a control signal output from the main CPU 41 and distributes coins recognized by the coin counter 21C as true coins into a cash box (not shown in the figure) or the hopper 66, which are disposed in the slot machine 10. In other words, when the hopper 66 is filled with coins, true coins are distributed into the cash box by the reverter 21S. On the other hand, when the hopper 66 is not filled with coins, true coins are distributed into the hopper 66. The cold cathode tube 81 works as a backlight installed on the back face sides of the lower image display panel 16 and the upper image display panel 33 and is lit up based on a control signal output from the main CPU 41.

Hereinafter, there will be described prizes according to the present embodiment.

FIG. 6 is a view illustrating the relationship between combination prizes and numbers of coins to be paid out.

If five “APPLE” symbols are arranged along the winning line L and, thus, winning of a bonus game trigger occurs, this causes a bonus game. In a bonus game, a free game is executed a predetermined number of times, based on random numbers resulted from the execution of a random-number generation program included in the symbol determination program.

Also, when five “JACKPOT7” symbols are arranged along the winning line L, then 30 coins are paid out per single inserted coin. Similarly, if five “BLUE7” symbols, five “BELL” symbols, five “STRAWBERRY” symbols, five “PLUM” symbols, five “CHERRY” symbols or five “ORANGE” symbols are arranged along the winning line L, a number of coins which corresponds to the corresponding one of the respective combination prizes are paid out.

FIG. 7 is a view illustrating a relationship between scatter prizes and numbers of coins to be paid out.

A table illustrated in FIG. 7 has scatter-prize fields, number-of-arranged-symbols fields and scatter-flag fields. In the scatter-prize fields, eight types of symbols “CHERRY”, “BELL”, “STRAWBERRY”, “ORANGE”, “PLUM”, “BLUE7”, “JACKPOT7” and “APPLE” are stored.

The number-of-arranged-symbols fields are divided into fields of “three” arranged symbols, fields of “four” arranged symbols and fields of “five or more” arranged symbols. In the respective number-of-arranged-symbols fields, there are stored numbers of coins to be paid out in association with the types of prizes. For example, if three “BLUE 7” symbols are arranged, 20 coins will be paid out per single inserted coin. If four “BLUE 7” symbols are arranged, 40 coins will be paid out per single inserted coin.

Further, in the scatter-flag fields, any one of scatter flags “1” and “0” is stored. The scatter flag “1” indicates that the corresponding symbol has been set to be a scatter symbol (the prize of the corresponding row has been made effective). On the other hand, the scatter flag “0” indicates that the symbol of the corresponding row has not been set to be a scatter symbol.

Next, description will be given of a processing performed in the slot machine 10.

The main CPU 41 reads and executes the game program so that a game is progressed.

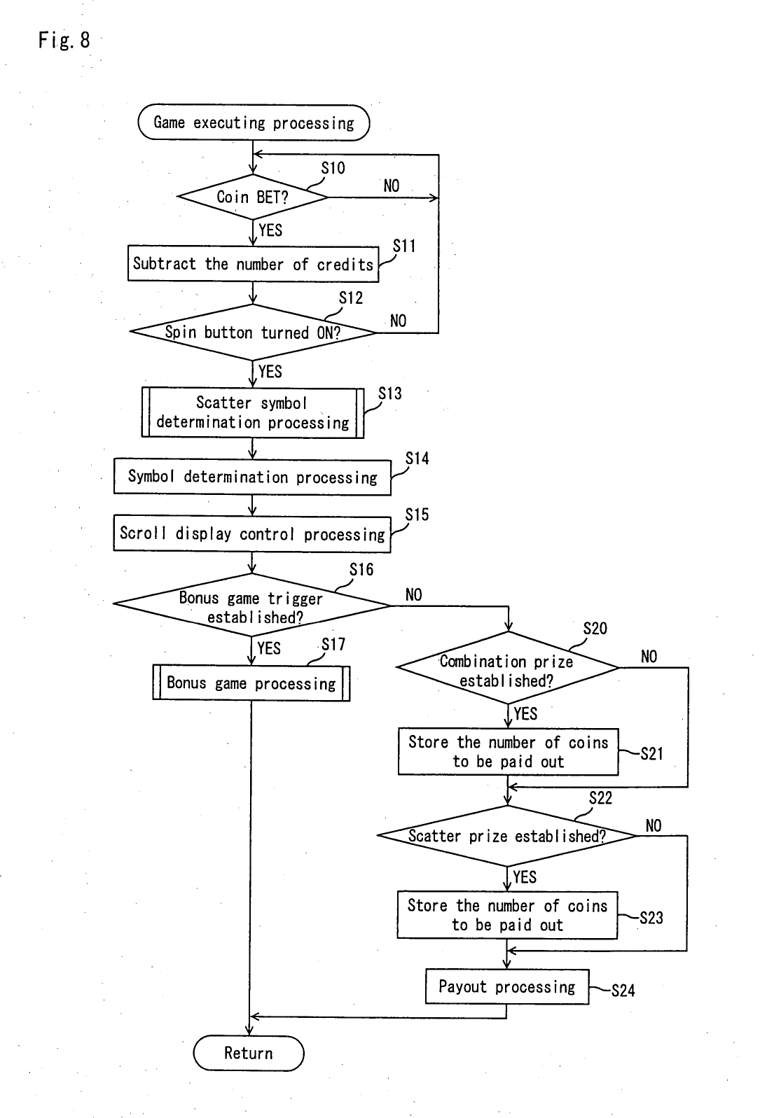

FIG. 8 is a flowchart showing a subroutine of a game execution processing.

In the game execution processing, the main CPU 41 at first determines whether or not a coin is BET (step S10). In the processing, the main CPU 41 determines whether an input signal output from the 1-BET switch 26S or the maximum BET switch 27S has been received or not when the 1-BET button 26 or the maximum BET button 27 is operated, respectively. When it is determined that a coin has not been BET, the process returns to step S10.

On the other hand, when it is determined in step S10 that a coin is BET, the main CPU 41 conducts a processing for subtracting the number of credits stored in RAM 43 according to the number of BET coins (step S11). In a case where the number of BET coins is more than the number of credits stored in RAM 43, the process returns to step S10 without conducting subtraction on the number of credits stored in RAM 43. In a case where the number of BET coins exceeds the upper limit (50 coins in the present embodiment) up to which a BET is possible in one game, the process advances to step S12 without conducting a processing for subtracting the number of BET coins from the number of credits stored in RAM 43.

The main CPU 41 determines in step S12 whether the spin button 23 has been turned ON or not. In the processing, the main CPU 41 determines, when the spin button 23 is pressed, whether an input signal output from the spin switch 23S has been received or not.

When it is determined that the spin button 23 has not been turned ON, the process returns to step S10. Note that in a case where the spin button 23 has not been turned ON (for example, in a case where a command of terminating a game has been input without turning ON the spin button 23), the main CPU 41 cancels a result of the subtracting processing in step S11.

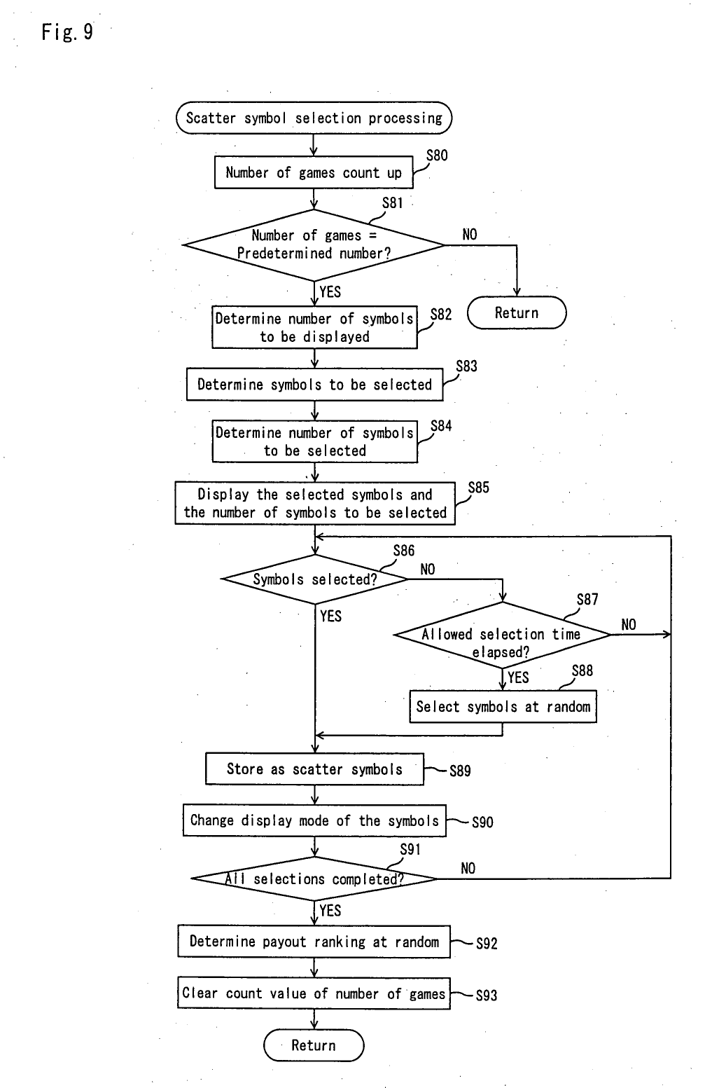

On the other hand, when the main CPU 41 determines, at the step S12, that the spin button 23 has been pushed, the main CPU 41 conducts scatter-symbol selection processing (step S13). Scatter-symbol determination processing will be described in detail later with reference to FIG. 9.

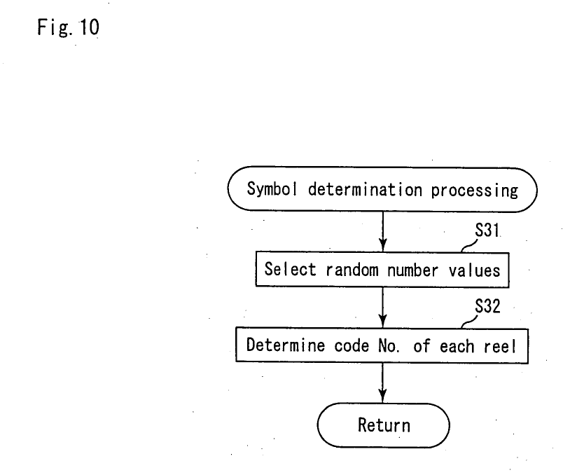

Next, the main CPU 41 conducts symbol determination processing (step S14). In the symbol determination processing, the main CPU 41 executes a symbol determination program stored in the RAM 43 to determine the code Nos. at the time of stopping of symbols. This processing will be described in detail later with reference to FIG. 10. Further, in the present embodiment, there will be described a case where the symbols to be rearranged are determined to determine one or a plurality of prizes from plural types of prizes. However, it is possible in the present invention that, for example, one or a plurality of prizes to be selected is first determined out of plural types of prizes and, thereafter, a combination of symbols to be rearranged can be determined based on the aforementioned prize.

Next, at step S15, the main CPU 41 conducts scroll-display control processing. This processing is processing for controlling the display such that the symbols determined at the step S14 are rearranged after the start of scrolling of symbols.

Next, the main CPU 41 determines whether or not a bonus game trigger has been established, namely whether or not “APPLE” symbols have been arranged along the winning line L (step S16). When the main CPU 41 determines that a bonus game trigger has been established, then the main CPU 41 reads, from the RAM 43, a program for executing a bonus game and executes the bonus game processing (step S17) and ends the present subroutine. The bonus game processing will be described in detail later with reference to FIG. 11.

When the main CPU 41 determines that no bonus game trigger has been established at step S16, the main CPU 41 determines whether or not a combination prize has been established (step S20). When the main CPU 41 determines that a combination prize has been established, the main CPU 41 stores, in the RAM 43, a number of coins to be paid out which corresponds to the number of inserted coins and the combination prize (see FIG. 6) (step S21).

When no combination prize has been established (step S20: NO) or after the processing at the step S21, the main CPU 41 determines whether or not a scatter prize has been established (step S22). When the main CPU 41 determines that a scatter prize has been established, the main CPU 41 stores, in the RAM 43, a number of coins to be paid out which corresponds to the number of inserted coins and the scatter prize (see FIG. 7) (step S23).

If it is determined, at the step S22, that no scatter prize has been established, or after the processing at the step S25, the main CPU 41 sums the numbers of coins to be paid out stored in the RAM 43, then pays out a number of coins which corresponds to the resultant sum (step S24) and ends the present subroutine.

FIG. 9 is a flow chart illustrating the subroutine of scatter-symbol selection processing.

First, the main CPU 41 counts up the number of games, based on input signals which are output from the spin switch 23S when the spin button 23 is pressed (step S80).

Next, at a step S81, the main CPU 41 determines whether or not the number of games has reached a predetermined number. When the main CPU 41 determines that the number of games has not reached the predetermined number, then it ends the present subroutine. On the other hand, when the main CPU 41 determines that the number of games has reached the predetermined number, then it determines the number of symbols to be displayed (step S82).

Next, at a step S83, the main CPU 41 determines symbols which can be selected, the number of which corresponds to the number of symbols to be displayed. Accordingly, for example, as illustrated in FIG. 1, five symbols which can be selected are displayed on the upper image display panel 33.

Next, at a step S84, the main CPU 41 determines the number of symbols to be selected. Accordingly, for example, as illustrated in FIG. 1, a number-of-selections image 201 indicating that three symbols should be selected out of the symbols which can be selected is displayed on the upper image display panel 33, and that selections of such three symbols are received.

Next, at a step S85, the main CPU 41 displays, on the upper image display panel 33, an image based on the number of symbols to be displayed, the symbols which can be selected and the number of symbols to be selected, which have been determined (see FIG. 1).

Next, at a step S86, the main CPU 41 determines whether or not symbols have been selected. In this processing, the main CPU 41 determines whether or not it has received symbol selection signals from the touch panel 69 output through player's operations. When the main CPU 41 determines that no symbol has been selected, then the main CPU 41 determines whether or not an allowed selection time period has elapsed (step S87). When the main CPU 41 determines that the allowed selection time period has not elapsed, then the main CPU 41 returns the process to the step S86. On the other hand, when the main CPU 41 determines that the allowed selection time period has elapsed, then the main CPU 41 selects symbols at random (step S88).

When symbols have been selected at the step S86 or after the processing at the step S88, the main CPU 41 stores, in the RAM 43, the selected symbols as scatter symbols. More specifically, the main CPU 41 sets the scatter flags for the selected symbols to “1”, in the table illustrated in FIG. 7.

Next, at the step S90, the main CPU 41 changes a display mode of the selected symbols by displaying an overlay image on the symbols (see FIG. 2B).

Next, at a step S91, the main CPU 41 determines whether or not all the selections have been completed. If all the selections have not been completed, then the main CPU 41 returns the process to the step S86.

If all the selections have been completed at the step S91, the main CPU 41 clears the count value of the number of games (step S93) and ends the present subroutine.

FIG. 10 is a flowchart showing a subroutine of a symbol determination processing called and executed in step S14 of the subroutine shown in FIG. 8. The processing is a processing conducted by executing a symbol determination program stored in RAM 43 with the main CPU 41. The main CPU 41 executes a random number generating program included in the symbol determination program, and a random number value from the numerical value range of 0 to 255 is selected thereby such that each of the selected random number values correspond to each of the symbol sequences (step S31). In the present embodiment, description will be given of a case where random numbers are generated on a program (a case where so-called software random numbers are used). In the present invention, however, a random number generator may be used, and random numbers may be extracted therefrom (so-called hardware random numbers may be used).

Then, the main CPU 41 determines, based on the selected five random number values, code Nos. (see FIG. 4) for each of the symbol sequences (step S32). The code Nos. of the symbol sequences correspond to code Nos. of the symbols stop displayed along the winning line L. The main CPU 41 determines code Nos. of the symbol sequences to thereby determine a prize. For example, in a case where code Nos. of the symbol sequences are determined “00”, “00”, “00”, “00” and “00”, it means that the main CPU 41 determined a prize as “JACKPOT 7”.

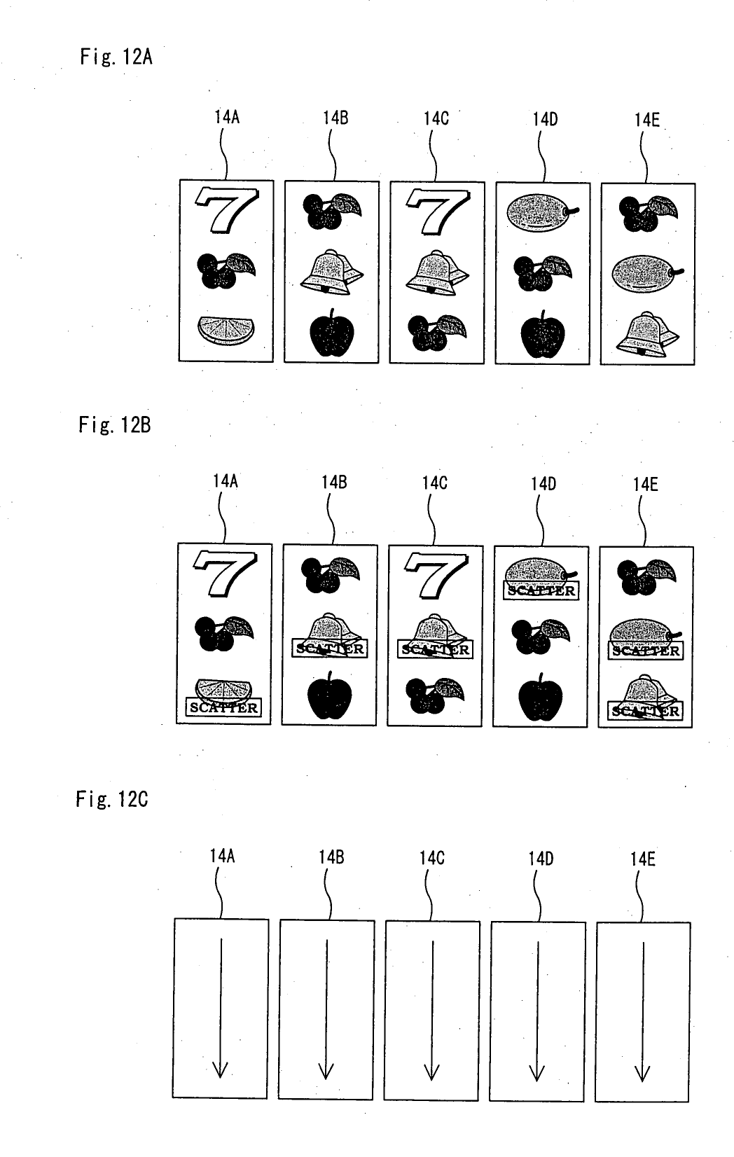

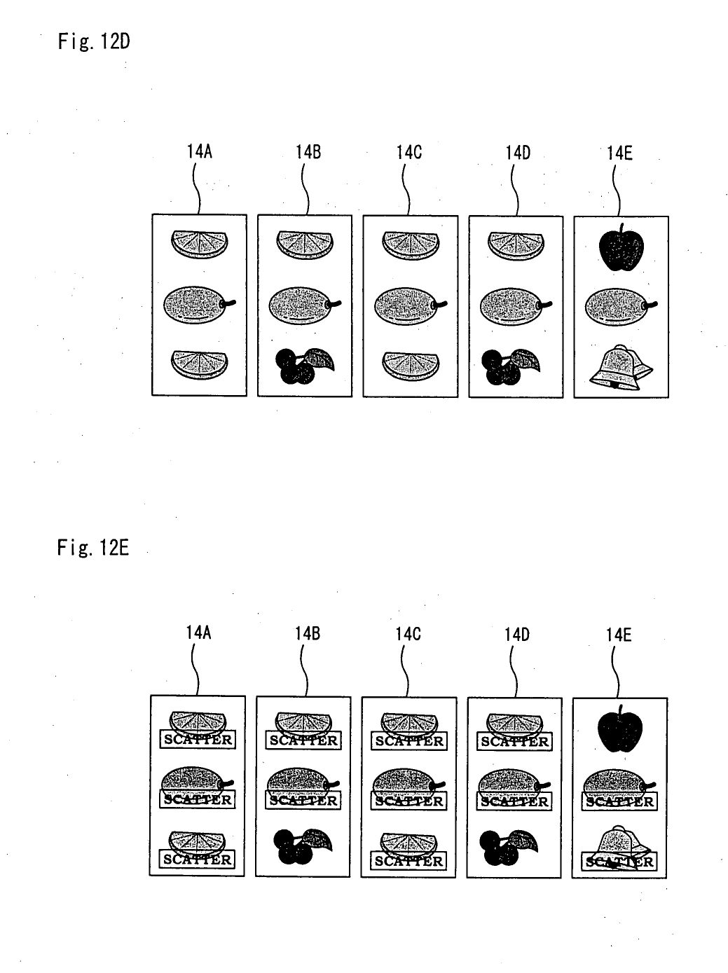

FIG. 12 is a flowchart showing a subroutine of a bonus game processing called and executed in step S17 of the subroutine shown in FIG. 8. In the bonus game processing, firstly, the main CPU 41 determines a number T of bonus games from 10 to 25 games, based on a random number value obtained by executing a random number generation program included in a symbol determination program stored in RAM 43 (step S60). The main CPU 41 stores as data into RAM 43 the number of games of the determined bonus games.

Subsequently, the main CPU 41 conducts scatter-symbol selection processing (step S61), symbol determination processing (step S62), and scroll-display control processing (step S63). The processing at the steps S61 to S63 is substantially the same as the processing described with reference to FIG. 8. This processing has been already described and description thereof is omitted herein.

Next, the main CPU 41 determines whether or not a bonus game trigger has been established, namely whether or not “APPLE” symbols have been arranged along the winning line L (step S64). When it is determined that the bonus game trigger has been established, the number t of additional games of the bonus game is determined (step S65) and the determined number t of additional games is added to the number T of games of the bonus game at that time (step S66). Thus, when a bonus game is hit during the bonus game, a remaining number of bonus games increases. More specifically, for example, in a case where a gaming state shifts to 20 bonus games for the first time, and hits 17 bonus games upon conducting a twelfth game 12 of the bonus games, another 25 bonus games (20 bonus games−12 bonus games+17 bonus games) are to be conducted.

If no bonus game trigger has been established at the step S64, the main CPU 41 determines whether or not a combination prize has been established (step S71). The processing at the steps S71 to S75 is substantially the same as the processing at the steps S20 to S24 which has been already described, and description thereof is omitted herein.

When the processing at the step S66 has been executed, or when the processing at the step S75 has been executed, the main CPU 41 reads out the number of bonus games T stored in the RAM 43 and subtracts, by one, the number T of bonus games read out therefrom. Then, the main CPU 41 stores the subtracted number T of games in the RAM 43, again (step S69).

Then, the main CPU 41 determines whether the number T of bonus games reaches the number of games determined in step S60 or not (step S70). More specifically, the determination is made based on whether or not the number T of games stored in RAM 43 has become 0, and if the number T of games is not 0, that is, when it is determined that the number of bonus games played does not reach the number of games which were determined in step S60, the process returns to step S61, and the above-mentioned processing is repeated. On the other hand, when the number T of games is 0, that is, when it is determined that the number T of games has reached the number of games which were determined in step S60, the present subroutine is completed thereafter.

As described above, according to the slot machine 10 and the playing method thereof according to the present embodiment, symbols corresponding to inputs from the touch panel 69 (selection switch) are determined to be scatter symbols (particular symbols). Further, overlay images for indicating the scatter symbols are displayed in a superposed manner on these scatter symbols. Thereafter, when three (a predetermined number) or more scatter symbols are arranged on the lower image display panel 16 as a result of rearrangement of a plurality of symbols arranged on the lower image display panel 16 (display), a prize is allotted.

In the aforementioned example, there has been described a case where symbols are displayed (arranged) on the lower image display panel 16 constituted by a liquid crystal display panel. Hereinafter, there will be described a case where mechanical rotation reels are arranged at the back surface of a display and the rotation reels are used for arranging symbols on the display. The slot machine according to the present embodiment has an external appearance, a circuit structure and the like which are substantially similar to those of the aforementioned slot machine 10 and also executes flow charts which are substantially similar, except for the use of the rotation reels for arranging symbols, and therefore, description thereof other than the arrangement of symbols is omitted herein. Further, components corresponding to those of the slot machine 10 will be designated by the same reference symbols, in the following description.

FIGS. 12A to 12E are views illustrating another example of symbols arranged on the lower image display panel.

The lower image display panel 16 included in the slot machine 10 is provided with display windows 15 along 5 columns and 3 rows (15A, 15B, 15C, 15D and 15E) (not illustrated), and these display windows 15 enable viewing of the reels 14 (14A, 14B, 14C, 14D and 14E) provided at the back surface of the lower image display panel 16.

For example, if “BELL”, “ORANGE” and “PLUM” are selected as scatter symbols when the symbols illustrated in FIG. 12A are arranged on the lower image display panel 16 (see FIG. 1), overlay images indicating “SCATTER” are displayed at the corresponding parts of the lower image display panel 16 positioned in front of the symbols “BELL”, “ORANGE” and “PLUM” (see FIG. 12B).

Thereafter, the rotation reels 14 are rotated to start scrolling of symbols (see FIG. 12C). At this time, the overlay images displayed on the lower image display panel 16 are cleared.

Then, after elapse of a predetermined time period, symbols which have been scrolled are arranged as illustrated in FIG. 12D, for example. Thereafter, as illustrated in FIG. 12E, overlay images indicating “SCATTER” are displayed again at the corresponding parts of the lower image display panel 16 positioned in front of the symbols “BELL”, “ORANGE” and “PLUM”.

As described above, according to the aforementioned slot machine 10 and the playing method thereof, symbols corresponding to inputs from the touch panel 69 (selection switch) are determined to be scatter symbols (particular symbols). Then, after rearrangement of a plurality of symbols arranged on the lower image display panel 16 (display), overlay images for indicating scatter symbols are displayed in a superposed manner on the scatter symbols. In this case, if three (predetermined number) or more scatter symbols are arranged on the lower image display panel 16, a prize will be offered.

Although the embodiments according to the present invention are described in the above, the descriptions present only some of the specific examples, and are not intended to limit the present invention in any way and specific constitutions of each means and the like can be properly changed in terms of design. Besides, the effects described in the embodiments of the present invention are only the most preferable effects generated from the present invention and effects to be caused by the present invention is not limited to those described in the embodiments of the present invention.

In the above detailed description, for a better and easier understanding of the present invention, the description is mainly made on the featuring aspects of the present invention. The present invention is not limited to the embodiments in the above detailed description, and may be applied to other varieties of embodiments. Also, it is to be understood that the phraseology and terminology employed in this specification are used to precisely describe the present invention, and should not be regarded as limiting the interpretation of the present invention. Moreover, based on the conception described in the present specification, those skilled in the art will readily come up with other configuration, systems and methods and the like included in the conception of the present invention. As such, it should be elucidated that the claims include such equivalent constitutions insofar as they do not depart from the spirit and scope of the present invention. Further, the purpose of the foregoing abstract is to enable the U.S. Patent and Trademark Office and general public institutions, and those skilled in the art and the like who are not familiar with patent or legal terminology, to quickly determine the nature and essence of the technical disclosure of this application with a simple search. Therefore, the abstract is not intended to define the scope of the present invention, which should be measured by the description of the claims. Furthermore, for fully understanding the purposes and the featuring effects of the present invention, desirably, the present invention is interpreted with reference to published publications and the like.

The detailed descriptions aforementioned may be presented in terms of processing executed by a computer. Those descriptions and terms set forth in the above are described for the purpose that those skilled in the art understand the present invention in a most effective way. In the present specification, each step used for leading one result should be understood a self-consistent procedure. In each step, sending and receiving, or recording or the like of electrical or magnetic signals are performed. Although, such signals are expressed in bit, value, symbol, character, term, number and the like in processing of each step; however, it is important to note that those expressions are used simply for convenience of explanation. Moreover, processing in each step is in some cases described using expressions in common with those for human activities, but processing described in the present specification is in principle performed by various apparatuses. Furthermore, some other constitutions required for carrying out the respective step are considered to be self-explanatory from the aforementioned descriptions.

What is claimed as new and desired to be secured by Letters Patent of the United States is:

1. A slot machine comprising:
a display to which a plurality of symbols are arranged;
a selection switch for selecting a symbol that is to be a particular symbol, out of said plurality of symbols; and
a controller,
said controller determining the symbol corresponding to an input from said selection switch as the particular symbol,
changing a display mode of the determined particular symbol, and
allotting a prize in an event that a predetermined number or more of at least one particular symbol is arranged to said display as a result of rearrangement of the plurality of symbols arranged to said display.

2. The slot machine according to claim 1,
wherein
said controller further comprises
displaying an overlay image for indicating the particular symbol on the determined particular symbol.

3. The slot machine according to claim 2,
wherein
said controller further comprises
displaying said overlay image on the determined particular symbol, after rearrangement of the plurality of symbols.

4. A slot machine comprising:
a display to which a plurality of symbols are arranged;
a selection switch for selecting a symbol that is to be a particular symbol, out of said plurality of symbols; and
a controller,
said controller determining the symbol corresponding to an input from said selection switch as the particular symbol,
displaying an overlay image for indicating the particular symbol on the determined particular symbol, and
allotting a prize, in an event that a predetermined number or more of at least one particular symbol is arranged to said display as a result of rearrangement of the plurality of symbols arranged to said display.

5. A slot machine comprising:
a display to which a plurality of symbols are arranged;
a selection switch for selecting a symbol that is to be a particular symbol, out of said plurality of symbols; and
a controller,
said controller determining the symbol corresponding to an input from said selection switch as the particular symbol,
displaying an overlay image for indicating the particular symbol on the determined particular symbol, after rearrangement of the plurality of symbols arranged to said display, and
allotting a prize, in an event that a predetermined number or more of at least one particular symbol is arranged to said display as a result of rearrangement of the plurality of symbols arranged to said display.

6. A playing method of a slot machine comprising the steps of:
receiving an input from a selection switch for selecting a symbol that is to be a particular symbol, out of a plurality of symbols arranged to a display,
determining the symbol corresponding to the input from said selection switch as the particular symbol,
changing a display mode of the determined particular symbol, and
allotting a prize, in an event that a predetermined number or more of at least one particular symbol is arranged to said display as a result of rearrangement of the plurality of symbols arranged to said display.

7. The playing method of a slot machine according to claim 6,
further comprising a step of:
displaying an overlay image for indicating the particular symbol on the determined particular symbol in said step of changing the display mode of the particular symbols.

8. The playing method of a slot machine according to claim 7,
further comprising a step of:
displaying said overlay image on the determined particular symbol, after rearrangement of the plurality of symbols in said step of changing the display mode of the particular symbol.

9. A playing method of a slot machine comprising the steps of:
receiving an input from a selection switch for selecting a symbol that is to be a particular symbol, out of a plurality of symbols arranged to a display,
determining the symbol corresponding to an input from said selection switch as the particular symbol,
displaying an overlay image for indicating the particular symbol on the determined particular symbol, and
allotting a prize, in an event that a predetermined number or more of at least one particular symbol is arranged to said display as a result of rearrangement of the plurality of symbols arranged to said display.

10. A playing method of a slot machine comprising the steps of:
receiving an input from a selection switch for selecting a symbol that is to be a particular symbol, out of a plurality of symbols arranged to a display,
determining the symbol corresponding to an input from said selection switch as the particular symbol,
displaying an overlay image for indicating the particular symbol on the determined particular symbol, after rearrangement of the plurality of symbols arranged to said display, and
allotting a prize, in an event that a predetermined number or more of at least one particular symbol is arranged to said display as a result of rearrangement of the plurality of symbols arranged to said display.
